(19) United States
(12) Patent Application Publication
(10) Pub. No.: US 2006/0092141 A1
(43) Pub. Date: May 4, 2006

(54) Modular tablet for holding electronic devices

(75) Inventors: Majid Amani, East Greenwich, RI (US); David Beck, Exeter, RI (US); Roy Patrick Lyman, Coventry, RI (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/261,339

(22) Filed: Oct. 28, 2005

Related U.S. Application Data
(60) Provisional application No. 60/623,842, filed on Oct. 29, 2004.
(60) Provisional application No. 60/623,844, filed on Oct. 29, 2004.

(51) Int. Cl. G09G 5/00

(52) U.S. Cl. 345/173

(57) ABSTRACT

A tablet assembly that can support various electronic devices in different orientations. Generally, the tablet assembly includes a tablet frame for supporting one or more repositionable, modular electronic device housings. Repositioning allows the housings to be arranged in different configurations to suit the handedness or desires of an operator of the electronic devices. The electronic device housings define receptacles that are configured to receive the electronic devices but still allow their operation. In addition, the housings may include communications connections that interconnect the housings, and the electronic devices to allow them to communicate with each other. Further, the table frame may be configured to extend outwards from the electronic device housings so as to provide gripping surfaces and impact resistance to protect the electronic devices contained therein.

### CROSS REFERENCE TO RELATED APPLICATIONS

The contents of co-pending Design patent application Ser. No. 29/216,146, filed Oct. 29, 2004 and entitled “MODULAR TABLET FOR ELECTRONIC DEVICES” is incorporated by reference in its entirety; and this application claims priority from U.S. Provisional Application No. 60/623,842, filed Oct. 29, 2004 and entitled “MODULAR TABLET FOR HOLDING ELECTRONIC DEVICES”; U.S. Provisional Application No. 60/623,844, filed Oct. 29, 2004 and entitled “MODULAR TABLET FOR HOLDING ELECTRONIC DEVICES”.

### FIELD OF THE INVENTION

The present invention is related to tablets for supporting electronic devices and more particularly, to a portable tablet assembly for supporting electronic devices.

### BACKGROUND OF THE INVENTION

Portable electronic devices are commonly used in commercial applications. These devices allow for great flexibility in the location and timing of commercial operations and/or transactions. As a result, such devices also improve commercial efficiency.

Advantageously, portable electronic devices allow commercial operations and transactions to take place at the point of need, rather than taking place at a tethered point of electronic access. For example, these portable devices allow a grocery store employee to gather and input inventory information while walking along the aisles of a grocery store. The portable devices also allow a car rental return agent to print and distribute a receipt before a customer leaves the front seat of her rental car.

Some commercial applications require the use of only one portable electronic device, whereas other applications require the use of two or more devices. Use of multiple devices requires the operator to simultaneously carry all of the devices needed to accomplish the operation or transaction. Commercial applications where two or more portable electronic devices are used can be further complicated by a need for the devices electronically communicate with each other. For example, personal data assistants and printers may need to be connected to allow onsite printing of labels, badges, etc.

Another drawback of multiple electronic devices is that they can also be relatively heavy or uncomfortable to carry for long periods of time. Further, the electronic devices can be damaged if dropped or in a collision with the environment.

One conventional solution (PRINTPAD, O'NEIL PRODUCT DEVELOPMENT, Irvine, Calif.) facilitating transport and use of multiple electronic devices includes a portable printer with a fixed housing that has been extended to form a receptacle for receiving a personal data assistant or other handheld data processing device. When placed in the housing, the data processing device connects in communication with the printer via a communications contact or pluggable interface. This allows the operator carry the portable printer and the data processing device at the same time, and to print from the data processing device using the portable printer. Despite the advantages of the PRINTPAD, there remains a need for an apparatus that can house one or more portable electronic devices for convenient use by an operator.

It would be advantageous, therefore, to have an apparatus that is easily transportable and can support electronic devices in a manner readily accessible to the operator. In addition, it would also be advantageous to have an apparatus that facilitates electronic communication between multiple, supported devices. Additionally, it would be advantageous to have an apparatus that can protect the electronic devices in the event of a fall or other blunt impact.

### BRIEF SUMMARY OF THE INVENTION

The present invention addresses the above needs and achieves other advantages by providing a tablet assembly that can support various electronic devices in different orientations. Generally, the tablet assembly includes a tablet frame for supporting one or more repositionable, modular electronic device housings. Repositioning allows the housings to be arranged in different configurations to suit the handedness or desires of an operator of the electronic devices. The electronic device housings define receptacles that are configured to receive the electronic devices but still allow their operation. In addition, the housings may include communications connections that interconnect the housings, and the electronic devices to allow them to communicate with each other.

Further, the table frame may be configured to extend outwards from the electronic device housings so as to provide gripping surfaces and impact resistance to protect the electronic devices contained therein.

In one embodiment, the present invention includes a tablet assembly for supporting one or more electronic devices, the tablet assembly comprising a tablet frame, and one or more electronic device housings configured to releasably attach to the tablet frame in at least two different positions. The electronic device housing defines a receptacle for releaseably receiving the electronic device, and releasable attachment of the electronic device housing in the different positions selectively changes positioning of the electronic device.

In another embodiment, the invention includes a pair of releaseably attached end caps that extend around a portion of the electronic electronic device housing. In one aspect, each of the end caps has a grippable protrusion. The grippable protrusion can be spaced apart and positioned at the ends of the end caps. The end caps themselves may include a grippable texture on the outer surface.

In another embodiment, the apparatus includes a second electronic device housing, adjacent to the first, and similarly configured to releasably attach to the tablet frame in two different positions. The two different positions may result in at least two different orientations of the second electronic device.

In another aspect, the apparatus establishes communication between the electronic devices. The electronic device housings may include communication contacts configured to establish communication with the electronic device when placed in the housing and the other one of the electronic housings when attached to the tablet frame.

In yet another aspect, the tablet frame includes a protective wall structure configured to shield the electronic device from impact. For example, the wall structure may include a pair of releasable end caps configured to attach to ends of a pair of support members. The releasable end caps are configured to extend around a portion of the electronic device housing. The end caps may also include a wall structure configured to extend beyond the peripheral edges of the electronic device when the electronic device is received in the electronic device housing.

The tablet assembly of the present invention has several advantages that allow an operator to easily transport and protect one or more portable electronic devices so that they are readily accessible to the operator. The modularity of the present design allows one or more of the electronic device housings to be positioned in two different positions, each of which results in a different orientation of the electronic device. The electrical connection in the electronic device housing allows for electrical communication between electronic devices thus facilitating commercial operations or transactions requiring more than one electronic device. Also, the peripheral dimensions of the end caps extend beyond the peripheral dimensions of the electronic device so that the electronic device is protected if the tablet assembly is dropped or subjected to a blunt force.

### BRIEF DESCRIPTION OF THE DRAWINGS

Having thus described the invention in general terms, reference will now be made to the accompanying drawings, which are not necessarily drawn to scale, and wherein:

FIG. 1 shows a perspective view of a tablet assembly of one embodiment of the present invention holding two electronic devices;

FIG. 2 shows a perspective view of the tablet assembly shown in FIG. 1 without the electronic devices;

FIG. 3 shows a top view of the tablet assembly shown in FIG. 2;

FIG. 4 shows a bottom view of the tablet assembly shown in FIG. 2;

FIG. 5 shows a front view of the tablet assembly shown in FIG. 2;

FIG. 6 shows a rear view of the tablet assembly shown in FIG. 2;

FIG. 7 shows a left side view of the tablet assembly shown in FIG. 2;

FIG. 8 shows a right side view of the tablet assembly shown in FIG. 2;

FIG. 9 shows an enlarged perspective view of an attachment feature of an end cap of the tablet assembly of FIG. 2;

FIG. 10 shows an exploded assembly view of the tablet assembly shown in FIG. 2; and

FIG. 11 shows a block diagram illustrating an electrical wiring scheme of the tablet assembly of FIG. 2.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

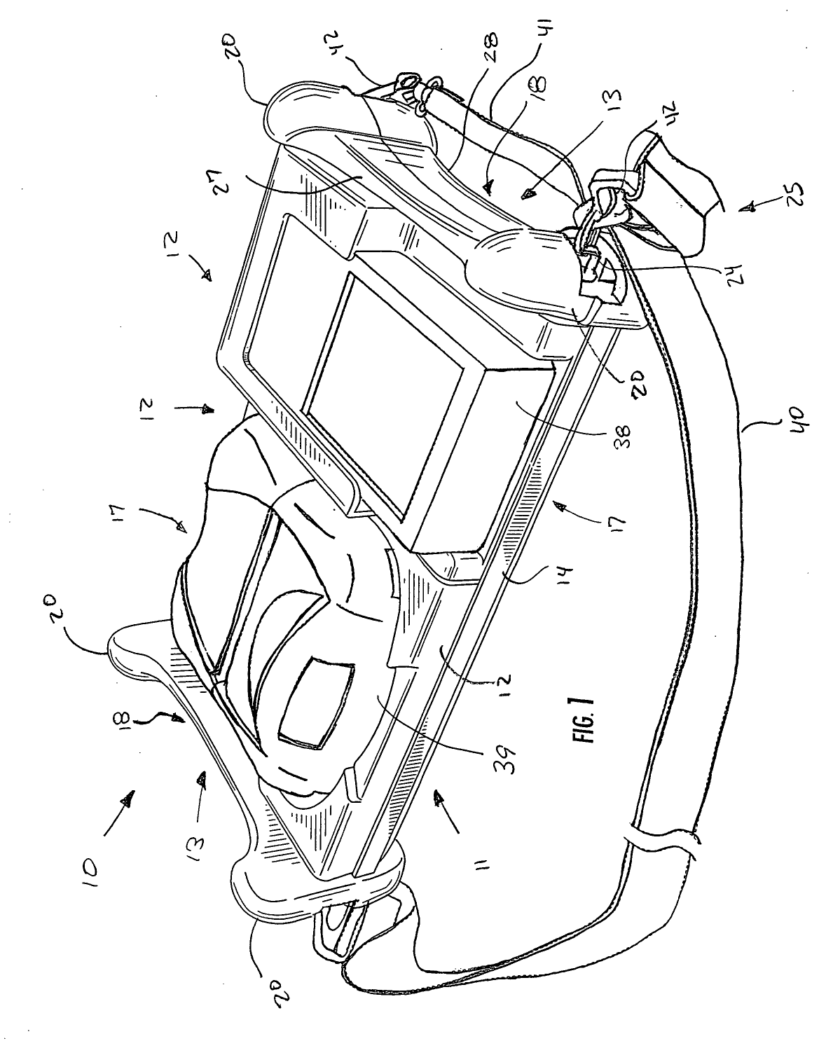

Generally, a tablet assembly 10 of one embodiment of the present invention includes a tablet frame 11, a pair of end caps 13, and one or more (in the illustrated embodiment, two) electronic device housings 12, as shown in FIG. 1. Advantageously, the electronic device housings 12 can each hold an electronic device, and can be rearranged into different support positions within the tablet frame 11 to suit the needs of an operator. In addition, the tablet assembly facilitates easy, hands-free and safe transport of multiple electronic devices, as will be explained in more detail below.

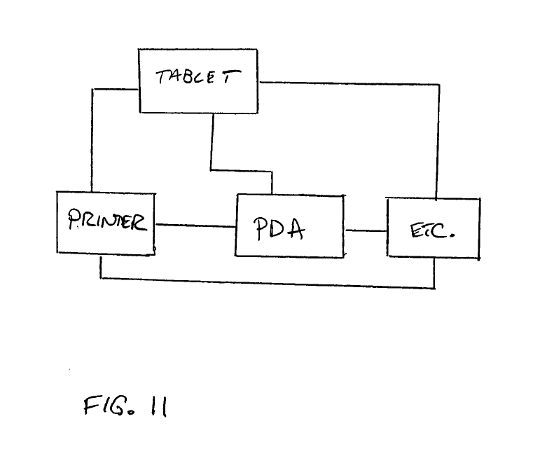

In the illustrated embodiment, the tablet frame 11 of the tablet assembly 10 includes a pair of support members 14 and two end caps 13. Each of the support members 14 is an elongated structure with a rectangular cross-section and a pair of opposing ends 15, as shown in FIG. 10. When assembled, the elongated support members 14 are spaced apart from each other, extending across top and bottom ends of the electronic device housings 12 and into end caps 13 positioned on lateral sides of the tablet assembly 10.

Although the support members 14 of the illustrated embodiment have the rectangular cross-section, the cross-sectional shape could have varying shapes, such as a square, a triangle, an ellipse or some irregular shape for differences in fit, strength or aesthetic appearance. In addition, the support members could be longer or shorter, or have other varying shapes and dimensions, depending upon the number and size of electronic device housings 12 to be accommodated by the tablet frame 11. The support members 14 are preferably constructed of a light but strong material, such as a high grade plastic or polymer, or metal, such as aluminum, so as to help secure the electronic device housings 12, but still be easily transportable.

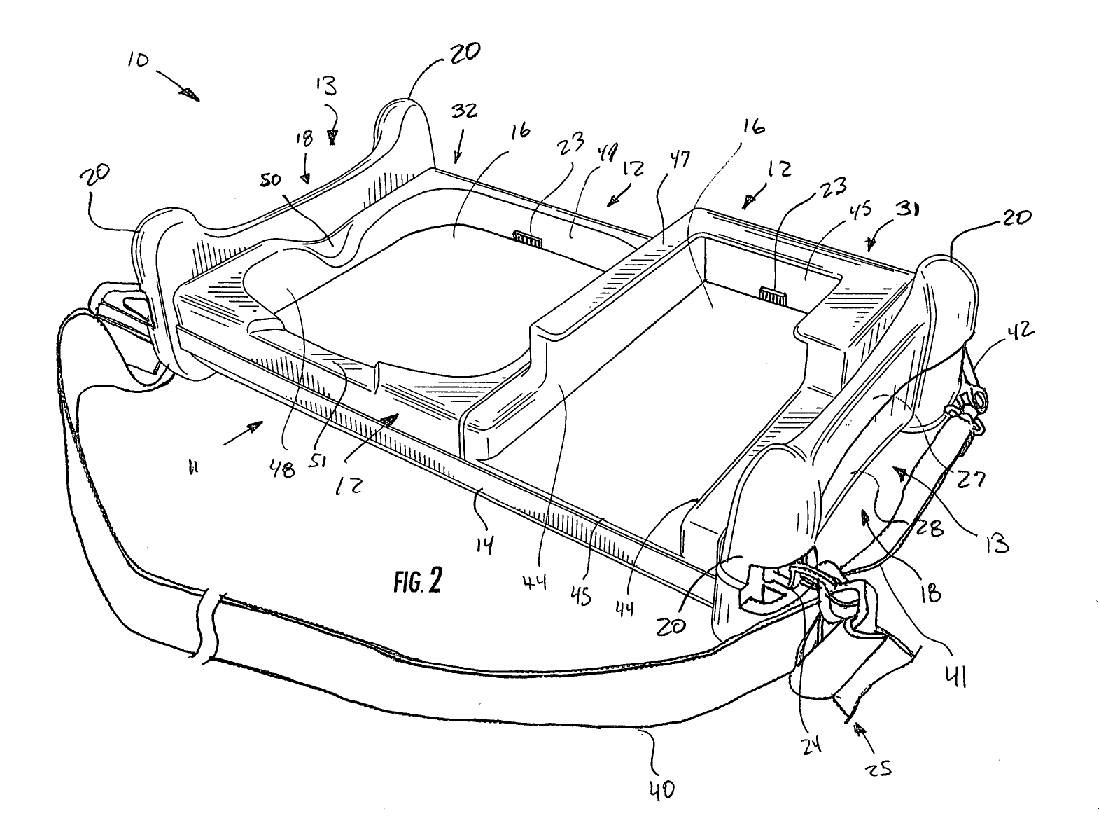

Each of the end caps 13 has an elongate structure with a pair of gripping portions 20 and a middle portion 18, as shown in FIG. 2. The gripping portions 20 of the end caps 13 in the illustrated embodiment have a rounded, cylindrical shape. The middle portion 18, as it extends between the gripping portions 20, tapers inward from the rounded, cylindrical shape of the gripping portions. As a result, each of the end caps 13 has a “dog-boned” shape which, when assembled, has protective and easily grippable properties as will be explained in more detail below.

Other shapes could be used for the end caps 13 and still provide a grippable surface, such as by including additional gripping portions 20, or the shape and size of the gripping portions could be varied, such as by being conical or having a pistol grip shape. Different materials, such as textured plastics, polymers or rubber could also be employed to improve gripping of the end caps 13. In addition, as described below, the general size and shape of the gripping portions 20 could be varied to allow for different sizes and numbers of electronic device housings 12. Materials better suited for construction of the end caps include light but impact resistant materials that absorb the shock of a drop or collision of the tablet assembly 10 with the environment, such as resilient polymeric or rubber material. These materials may also be included for their non-slip grip characteristics, such as a durable rubber coating or may be a solid rubber or resilient polymer.

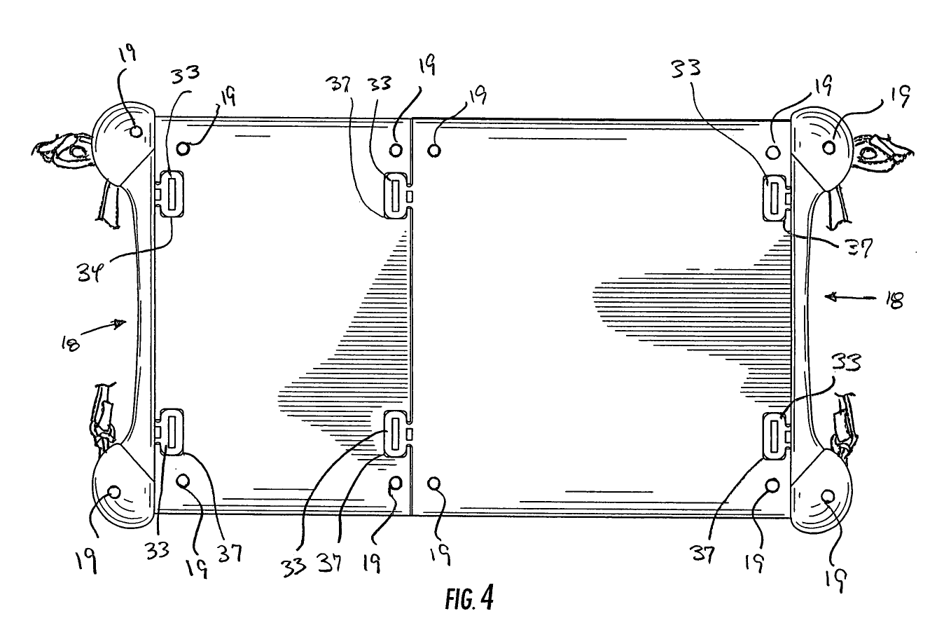

Defined in each of the end caps 13 are a pair of rectangular openings 21 configured to receive the rectangular opposing ends 15 of the support members 14 in a firm fit, as shown in FIG. 10. To facilitate a secure interconnection of the support members 14 and the end caps 13, the end caps may be split longitudinally into top and bottom portions 27 and 28. In this aspect, the bottom portion 28 defines the rectangular openings 21. Splitting of the end caps 13 into the top and bottom portions 27, 28 allows positioning of the opposing ends 15 of the support members 14 in the rectangular openings and transfixion by one of several fasteners 19 that also connect the top and bottom portions, as shown in FIG. 4.

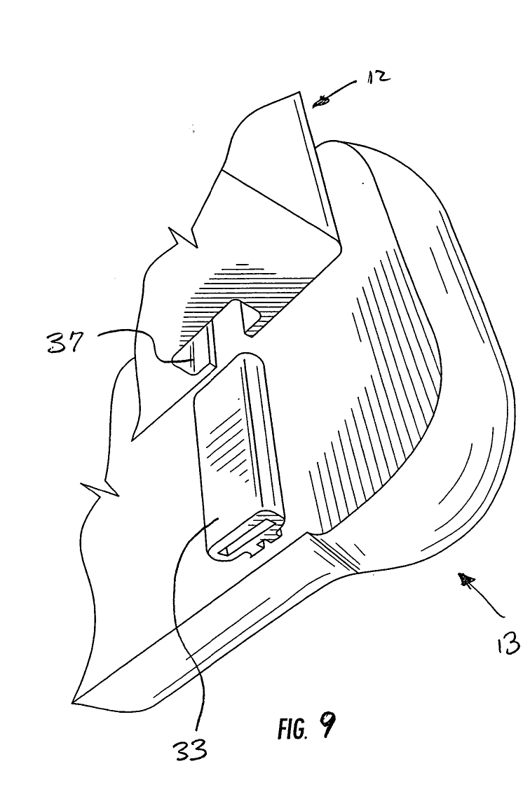

When the tablet frame 11 is assembled, the ends 15 of the support members 14 extend into the spaced apart end caps 13 so as to form a generally rectangular shape defining the periphery of the tablet assembly 10, as shown in FIG. 2. Advantageously, extension of the tablet frame 11 around the periphery of the electronic device housings 12 and the geometry of the end caps 13 secures and protects the electronic device housings 12, and any electronic devices 17 contained therein. For example, the grippable portions 20 extend outward at the corners of the tablet frame 11 in all directions, as shown in FIGS. 5 and 8, so as to be the first to impact the environment when the tablet assembly 10 is dropped. The general dog-boned shape of the end caps 13 also provides an easily grippable surface at the middle portion 18 due to its tapering shape that provides a handle grip for dual or single-handed carrying.

Notably, the rectangular shape could be varied in dimension, or the shape of the entire frame 11 could be varied, in order to extend around additional, or differently shaped, electronic device housings 12, and still be within the purview of the present invention. For example, the rectangular shape could be widened to fit a third or fourth electronic device housing. As another example, the tablet frame 11 could have an octagonal shape formed of alternating grippable members, such as the dog-bone shaped end caps 13, and support members 14 to allow grasping from different angles. However, the tablet frame generally benefits from having a geometry that extends outwards in most or all directions from the electronic device housings 12 for easy handling of the tablet assembly 10 and protection of electronic devices.

Handling of the tablet assembly 10 can be further improved by the provision of four anchors 24 positioned at the four corners of the tablet frame 11 which provide mounting points for one or more straps 25, as shown in FIGS. 1 and 2. In particular, four recesses are defined, one in each of the grippable portions 20 at each of the four corners of the tablet frame 11. The recesses extend above and below the split line separating the top and bottom portions 27, 28 of the end caps 13. Each of the anchors 24 includes a loop section mounted to an axle that extends upwards through holes defined in opposing surfaces of the surrounding recess of the grippable portion. In this manner, the anchors are free to rotate with respect to the tablet frame 11. Notably, the ability to separate the top and bottom portions 27, 28 allows mounting of the anchors 24 within the grippable portions 20.

The straps 25 include a primary shoulder strap 40 having ends each attached to one of a pair of secondary stabilization straps 41. Also at the ends of the shoulder strap 40 are clips 42 that are configured to snap onto a pair of the anchors 24 positioned on the end caps 13. In addition, the stabilization straps 41 extend away from the attachments at the ends of the shoulder strap 40, along the outer edges of the end caps 13, and attach to the remaining anchors 24. Thus, the stabilization straps 41 provide additional carrying stability by anchoring the tablet assembly 10 at all four corners. Overall, the straps 25 provide a convenient way to handle and transport the tablet assembly 10.

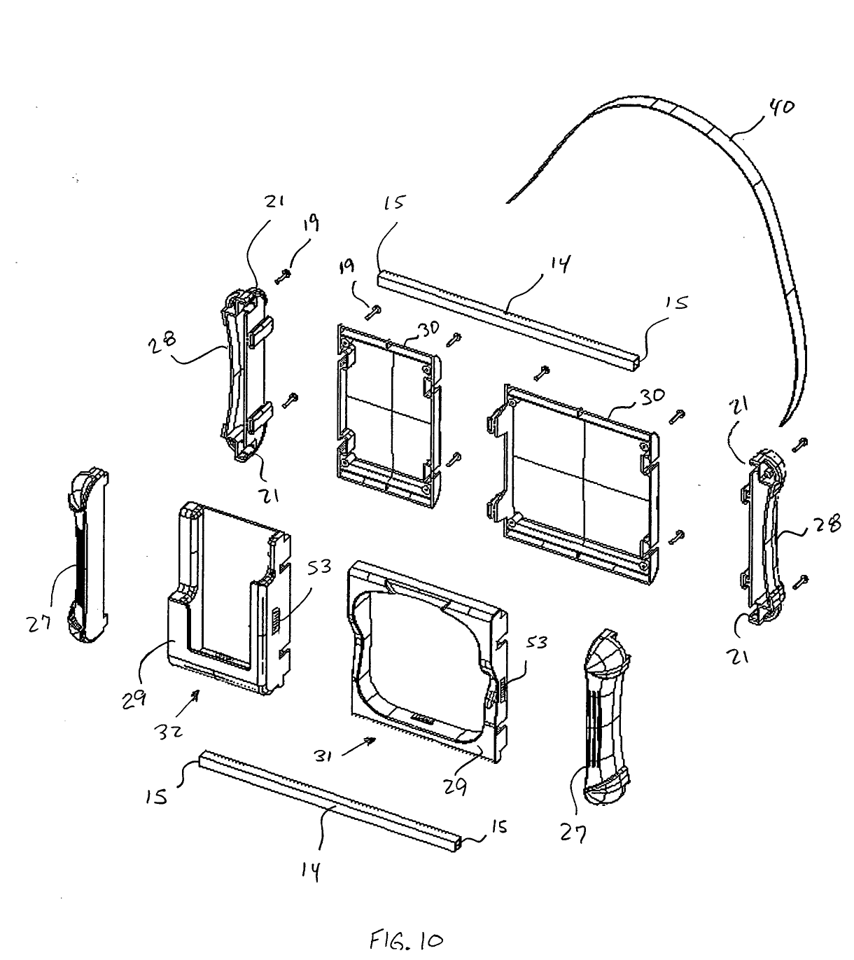

Each of the end caps 13 also includes a pair of attachment flanges 33 extending inwards from a flat surface 35 defined on an inner side of the bottom portion 28, as shown in FIG. 9. Each of the attachment flanges 33 has a narrow, fin-shaped base that is attached to the flat surface 35 and an elongate, rectangular shaped top end supported by the base so as to form a T-shaped cross-section. The T-shaped cross-section allows the attachment flanges to be slidably engaged into similarly shaped slots 37 defined in the electronic device housings 12, as shown in FIG. 4. Because the attachment flanges do not extend the entire way along the flat inner surfaces 35, the attachment flanges are advantageously not visible from the front of the tablet assembly 10, as shown in FIGS. 1-3. Of course other shapes could be defined by the attachment flanges 33 and slots 37 in the electronic device housings 12 and still promote easy attachment, such as L-shaped or F-shaped flanges 33 and slots 37. Similarly, more or less attachment flanges 33 and slots 37 could be employed for different levels of security and ease of attachment.

In the illustrated embodiment, two different types of electronic device housings 12 are shown, including a personal data assistant (PDA) housing 31 and a printer housing 32. Similar to the end caps 13, the electronic device housings 12 may be separated into top and bottom portions 29, 30 and assembled using the plurality of fasteners 19, as shown in FIG. 4. It should be noted that the term “electronic devices” as used herein denotes any type of electronic device including a printer, PDA, terminal, auxiliary battery, battery charger, radio transmitter, radio receiver, etc.

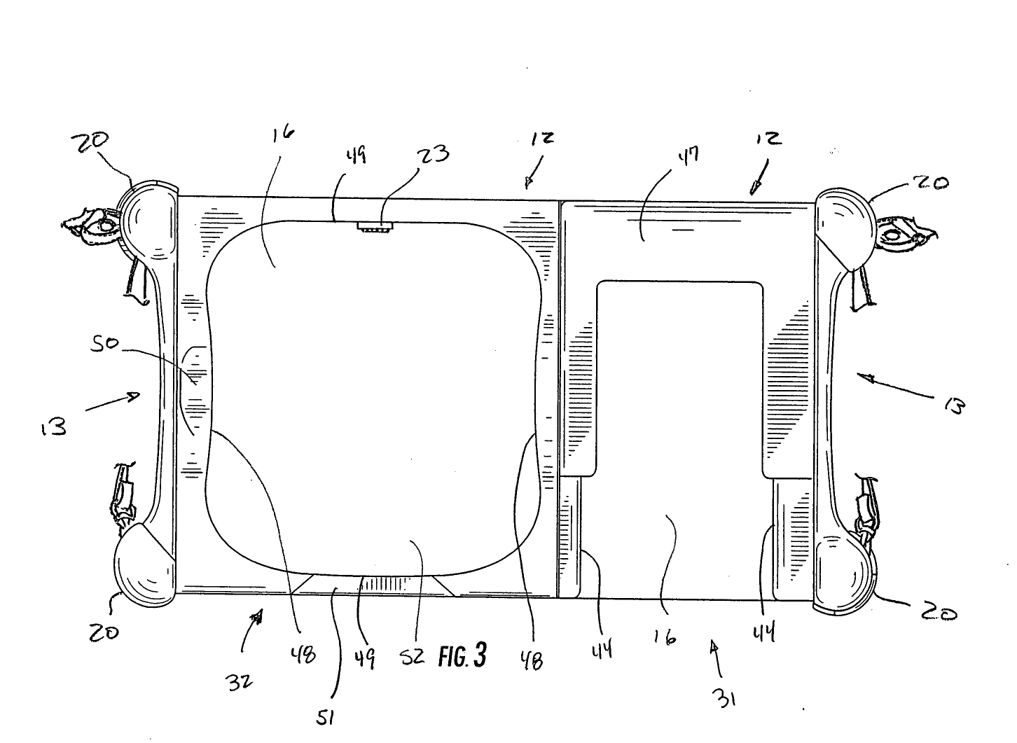

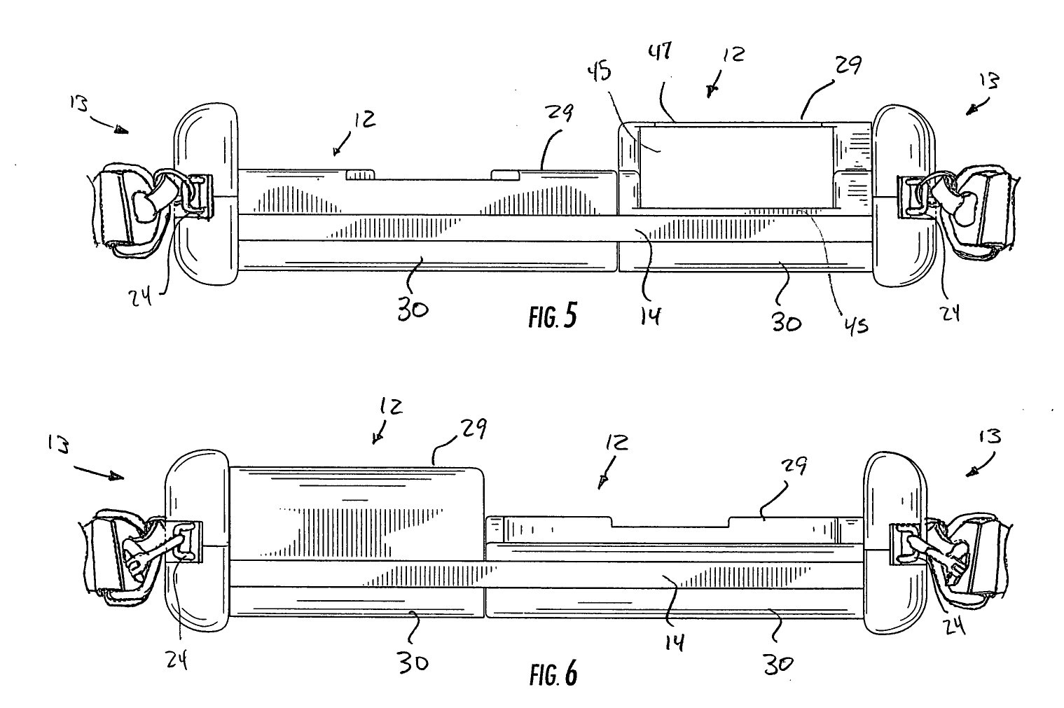

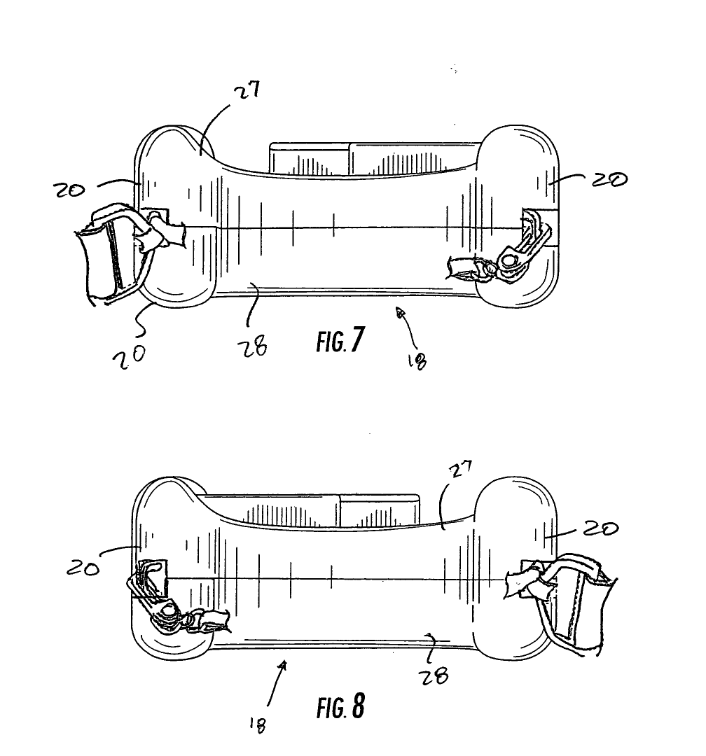

The PDA housing 31 has a rectangular shape with a pair of parallel, spaced long walls 44 between which extend a pair of parallel, spaced short walls 45, as shown in FIGS. 5-8. A rear wall extends between the long walls 44 and short walls 45, while a 30 front wall 47 extends inwardly a short distance from a portion of the long walls 44 and a bottom one of the short walls 45 so as to form a windowed, rectangular receptacle 16, as shown in FIGS. 3 and 5. Accordingly, this rectangular receptacle is sized and shaped to receive a PDA 38, as shown in FIG. 1. The windowed portion of the rectangular receptacle advantageously still allows viewing of a screen and touching of keypad controls on the PDA. Also, because the front wall 47 does not extend from a top one of the short walls 45, the operator is free to slide the PDA into, and out of, the rectangular receptacle 16. These features allow the PDA 38 or other electronic device 17 to be easily removed from the tablet assembly 10 so that the PDA 38 or other electronic device 17 may be used independent of the tablet assembly 10 if advantageous for a particular commercial operation or transaction.

The printer housing 32 defines its own receptacle 16, this one sized and shaped for receiving a printer 39. In particular, the printer housing includes a pair of side walls 48 that are parallel and spaced from each other and a pair of end walls 49 that are also parallel and extend between the side walls 48. A rear wall 52 provides a bottom for the receptacle 16. The inner edges of the walls 49, 48 are bowed near the center and rounded near the ends so as to define a rectangular shape with rounded corners for the receptacle 16 of the printer housing 32, a shown in FIG. 3. This shape is configured to snugly fit the rounded, rectangular shape of the edges of the printer 39, as shown in FIG. 1. Insertion and removal of the printer is facilitated by a finger indentation 50 that is defined in the top and inner surface of one of the side walls 48. Similarly, a cutout 51 defined in one of the end walls 49 facilitates insertion and removal of the printer 39, and also allows viewing of a screen of the printer for easy operation. These features allow the printer 39 or other electronic device 17 to be easily removed from the tablet assembly 10 so that the printer 39 or other electronic device 17 may be used independent of the tablet assembly 10 if advantageous for a particular commercial operation or transaction.

Each of the long walls 44 of the PDA housing define a spaced pair of the T-shaped slots 37 wherein the pair of T-shaped slots on one of the long walls is employed for attachment to the a pair of attachment flanges extending from one of the end caps 13. The other pair of the T-shaped slots 37 allows sliding engagement of a pair of attachment flanges 33 extending from one of the side walls 48 of the printer housing 32, as shown in FIG. 4. The other one of the side walls 48 of the printer housing 32 defines the T-shaped slots 37 so as to allow sliding attachment to the pair of flanges 33 extending from the other one of the end caps 13.

Advantageously, the uniform spacing and shape of the slots 37 and the flanges 33 allow the device housings 12 to be positioned in different orientations to suit the operator. For example, the printer housing 32 could be reoriented top-to-bottom, thereby moving the attachment flanges 33 to the opposite side. This allows the PDA housing 31, which has the T-shaped slots 37 on both of its long walls 44 to be switched from the right to the left side of the printer housing 32. In this manner, the two housings 12, and the devices held therein can be easily rearranged to suit right or left-handed operators. Notably, each of the housings can be repositioned by moving the housing, changing its orientation or doing both to allow several different combinations of positions.

It should be noted that repositioning of the electronic device housings 12 could have additional combinations if extended to three or more housings and still be within the scope of the present invention. For example, a cellular phone housing could be added that has a similar configuration of long walls each defining a pair of T-shaped slots 37, and wherein the printer housing 32 includes flanges 33 on both side walls 48 to allow positioning of the PDA housing 31 and the cellular phone housing on either of its sides. In addition, the electronic device housings 12 could be made symmetrical from front to back by having similarly shaped openings defined in the rear walls 46, 52 and by having the long and side walls 44, 48, and the inner surfaces 35 of the end caps 13, each define one of the attachment flanges 33 and one of the T-shaped slots 37. Such a configuration would allow rearrangement of the electronic device housings 12 regardless of their front-to-back orientations, providing the ability to have each of the three housings in the middle, or on the left or right sides, as desired. In addition, as noted above, other shaped sliding and non-sliding connections between the end caps 13 and the housings 12 may be employed, although the T-shaped slots 37 and attachment flanges 33 of the illustrated embodiment are particularly robust and easy to use.

In yet another aspect of the tablet assembly 10 of the present invention, each of the electronic device housings 12 may include electronic connections 23 for facilitating electrical communications between the electronic devices 17 as shown in FIG. 2, and to the tablet assembly 10. In the illustrated embodiment, the electrical connections are pluggable interfaces extending from one of the walls of the electronic device housings 12 and into the receptacle 16, preferably at its bottom, so as to extend into a similarly shaped female pluggable interface located at the bottom of the electronic devices 17. Additionally, the electronic device housings 12 may also include housing electronic connections 53 that allow electrical communication between adjacent electronic device housings 12, as shown in FIG. 10. These housing electronic connections 53 are placed on both sides of the top portion 29 of each electronic device housing 12 so that electrical communications will be maintained regardless of lateral positioning of the electronic device housings 12. It should be noted that the electronic connectors 53 can be placed on other areas of the electronic device housing 12 and still maintain electrical communications with adjacent electronic device housings 12. FIG. 11 shows a block diagram illustrating a wiring scheme for one embodiment of the present invention.

Different types of male or female pluggable interfaces or other types of connections could be employed for electronic communication between electronic devices 17 and/or from the electronic devices 17 to the tablet assembly 10, in lieu of the electronic connections 23 and the housing electronic connections 53. Physical interfaces, including conventional and specialized interfaces such as serial, parallel, digital, analog, USB, Firewire®, RS-232 connections, etc. could be employed. A pluggable interface that is similar to the same type of interface in which a PDA would interface with a docking station may also be employed. Additionally, wireless communications may be employed, including infrared, Bluetooth®, etc. Communication between the electronic devices 17 and the tablet assembly 10 may be employed using similar devices. Also, an electronic device, such as a radio transmitter or receiver could be integrated with the tablet assembly 10.

Assembly of the tablet assembly 10 is best described referring to FIG. 10. The attachment flanges 33 of the bottom portion 28 of the end cap 13 are inserted into the T-shaped slots 37 of the printer housing 32. The attachment flanges of the PDA housing 31 are then inserted into the T-shaped slots 37 of the printer housing 31. The attachment flanges 33 of the bottom portion 28 of the other end cap 13 are then inserted into the T-shaped slots 37 of the PDA housing 32. The support members 14 are then inserted into the rectangular openings 21 of the end caps 13. The top portions 29 of the printer housing 31 and the PDA housing 32 are then attached to the bottom portions 30 using fasteners 19. Finally, the top portions 27 of the end caps 13 are then fastened to the bottom portions 28 using fasteners 19. Alternatively, the top portions 29 and bottom portions 30 of the printer housing 31 and PDA housing 32 may be pre-assembled so as to reduce the number of assembly steps. It should be noted that many other alternate assembly schemes will come to mind to one skilled in the art to which these inventions pertain having the benefit of the teachings presented in the foregoing descriptions and the associated drawings.

The tablet assembly 10 of the present invention has several advantages that allow an operator to easily transport and protect one or more portable electronic devices 17 so that they are readily accessible to the operator. The modularity of the present design allows one or more of the electronic device housings 12 to be positioned in at least two different positions, each of which result in a different orientation or location of the electronic device 17. The electrical connection 23 in the electronic device housing 12 allows for electrical communication between electronic devices 17 thus facilitating commercial operations or transactions requiring more than one electronic device 17. Also, the peripheral dimensions of the end caps 13 extend beyond the peripheral dimensions of the electronic device 17 so that the electronic device is protected if the tablet assembly 10 is dropped or subjected to a blunt force.

Many other modifications and embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A tablet assembly for supporting one or more electronic devices, said tablet assembly comprising:
a tablet frame; and
at least two electronic device housings configured to releasably attach to the tablet frame in at least two different positions,
each of said electronic device housings defining a receptacle for releaseably receiving the electronic device,
wherein releasable attachment of the electronic device housings in the different positions selectively changes positioning of the electronic devices,
wherein the tablet frame includes a pair of releasable end caps configured to attach to ends of a pair of spaced support members, said end caps and spaced support members configured to extend around at least a portion of the electronic device housing,
wherein each of the end caps is an elongate structure with a pair of grippable protrusions spaced apart and positioned at ends of the end caps,
wherein each of the electronic device housings includes communication contacts configured to establish communication with the electronic device when placed in the housing and the other one of the electronic housings when attached to the tablet frame, so as to establish communication between the electronic devices.

2. A tablet assembly of claim 1, wherein at least one of the end caps includes a grippable texture on an outer surface.

3. A tablet assembly of claim 1, wherein the two different positions are different orientations at a same location.

4. A tablet assembly of claim 1, wherein the tablet frame includes at least one protective wall structure configured to shield the electronic device from impact.

5. A tablet assembly of claim 4, wherein each of the end caps includes the wall structure with portions configured to extend outwards further than peripheral edges of the electronic device when received in the electronic device housing.
